(19) United States
(12) Patent Application Publication
(10) Pub. No.: US 2004/0174125 A1
(43) Pub. Date: Sep. 9, 2004

(54) Method and apparatus for adaptive control of hybrid electric vehicle components

(75) Inventors: Thomas F. Wilton, Centennial, CO (US); Joshua J. Anderson, Edgewater, CO (US)

Correspondence Address: OLIFF & BERRIDGE, PLC, P.O. BOX 19928, ALEXANDRIA, VA, 22320, US

(73) Assignee: Transportation Techniques LLC, Denver, CO

(21) Appl. No.: 10/797,077

(22) Filed: Mar. 11, 2004

Related U.S. Application Data
(63) Continuation-in-part of application No. 10/413,544, filed on Apr. 15, 2003.
Application No. 10/413,544 is a continuation-in-part of application No. 09/748,182, filed on Dec. 27, 2000, now Pat. No. 6,573,675.

(51) Int. Cl. H02P 7/68

(52) U.S. Cl. 318/139; 318/109

(57) ABSTRACT

A hybrid electric vehicle having an energy generation system, an energy storage system and at least one electric motor includes a controller for controlling operation of vehicle systems. The controller determines which of a plurality of component configurations is selected. Based upon this determination, the controller establishes the vehicle components in the selected configuration and connected in the selected component architecture. The controller also generates commands based upon this determination to operate the vehicle in a control method corresponding to the determined component configuration. A method for implementing various component configurations is also disclosed.

This is a Continuation-in-Part of application Ser. No. 10/413,544 filed Apr. 15, 2003, which is a Continuation-in-Part of application Ser. No. 09/748,182 filed Dec. 27, 2000. The entire disclosure of the prior applications are hereby incorporated by reference herein in their entirety.

### BACKGROUND OF THE INVENTION

1. Field of Invention

This invention relates to methods and apparatus for adaptively controlling the vehicle component configuration of a hybrid electric vehicle in response to varying inputs or conditions.

2. Description of Related Art

The desire for cleaner air has caused various federal, state and local governments to adopt or change regulations requiring lower vehicle emissions. Furthermore, elevated fuel costs prompt consumer action to obtain vehicles for personal or business operations that consume less fuel or operate more efficiently.

Electric vehicles have been developed that produce zero emissions. Electric vehicles are propelled by an electric motor that is powered by a battery array on board the vehicle. The range of electric vehicles is limited as the size of the battery array which can be installed on the vehicle is limited. Recharging of the batteries can only be done by connecting the battery array to a power source. Electric vehicles are not truly zero emitters when the electricity to charge the battery array is produced by a power plant that burns, for example, coal.

Hybrid electric vehicles have also been developed to reduce emissions. Hybrid electric vehicles include an internal combustion engine and at least one electric motor powered by a battery array. In a parallel type hybrid electric vehicle, both the internal combustion engine and the electric motor are coupled to the drive train via mechanical means. The electric motor may be used to propel the vehicle at low speeds and to assist the internal combustion engine at higher speeds. The electric motor may also be driven, in part, by the internal combustion engine and be operated as a generator to recharge the battery array.

In a series type hybrid electric vehicle, the internal combustion engine is used only to run a generator that charges the battery array. There is no mechanical connection of the internal combustion engine to the vehicle drive train. The electric traction drive motor is powered by the battery array and is mechanically connected to the vehicle drive train.

Conventional internal combustion engine vehicles control propulsion by increasing and decreasing the flow of fuel to the cylinders of the engine in response to the position of an accelerator pedal. Electric and hybrid electric vehicles also control propulsion by increasing or decreasing the rotation of the electric motor or motors in response to the position of an accelerator pedal. Electric and hybrid electric vehicles may be unable to accelerate properly if the power available from the battery or batteries and/or genset is insufficient.

Conventional internal combustion engine vehicles may also include systems to monitor the slip of a wheel or wheels to thereby control the engine and/or the brakes of the vehicle to reduce the slip of the wheel or wheels. In hybrid electric vehicles, however, it is necessary to control the speed and torque of the electric motor or motors to control the slip of the wheels.

### SUMMARY OF THE INVENTION

The invention provides methods and apparatus for adaptively controlling the vehicle component configuration of a hybrid electric vehicle in response to varying inputs or conditions.

An exemplary embodiment of a hybrid electric vehicle according to the invention, including an energy generation system, an energy storage system receiving current at least from the energy generation system, and at least one electric drive motor receiving current from the energy storage system, is adaptively controlled so that the architecture of hybrid electric propulsion components and their related control configuration may be changed as a result of states and conditions of various vehicle inputs and external inputs and of system states and conditions.

According to an exemplary embodiment, a method for determining the component configuration of a hybrid electric vehicle having an energy generation system, an energy storage system receiving current at least from the energy generation system, and at least one electric drive motor receiving current from the energy storage system, consists of:

1. Determining the desired propulsion component configuration as a result of states and conditions of various vehicle and external inputs and of system states and conditions,

2. Reconfiguring the hybrid electric component architecture,

3. Setting the hybrid electric component states to correspond to the determined component configuration, and

4. Generating commands to operate the vehicle systems in accordance with the parameters of the determined component configuration.

In preferred embodiments, redundant systems may be provided for one or more of the energy generation system, energy storage system, and electric drive motors. Each may be selectively coupled or decoupled from other components through a series of relays. This allows for adaptive reconfiguration into multiple propulsion configurations, and is particularly advantageous to allow various “limp home” modes, should one or more components or systems fail during operation through adaptive reconfiguration.

### BRIEF DESCRIPTION OF THE DRAWINGS

Various exemplary embodiments of this invention will be described in detail with reference to the following figures, wherein like numerals reference like elements, and wherein:

FIG. 1 is a schematic view of an exemplary embodiment of a hybrid electric vehicle according to the invention;

FIG. 2 is a schematic diagram illustrating an exemplary embodiment of a hybrid electric vehicle architecture according to the invention;

FIG. 3 is a diagram illustrating the relationship between the power created, the power stored, and the power consumed by the series hybrid electric vehicle;

FIG. 4 is a diagram illustrating an exemplary embodiment of a driver's input control panel;

FIG. 5 is a flowchart illustrating an exemplary embodiment of a component configuration selection process; and

FIGS. 6-10 are flowcharts illustrating an exemplary control of the hybrid electric vehicle.

### DESCRIPTION OF EXEMPLARY EMBODIMENTS

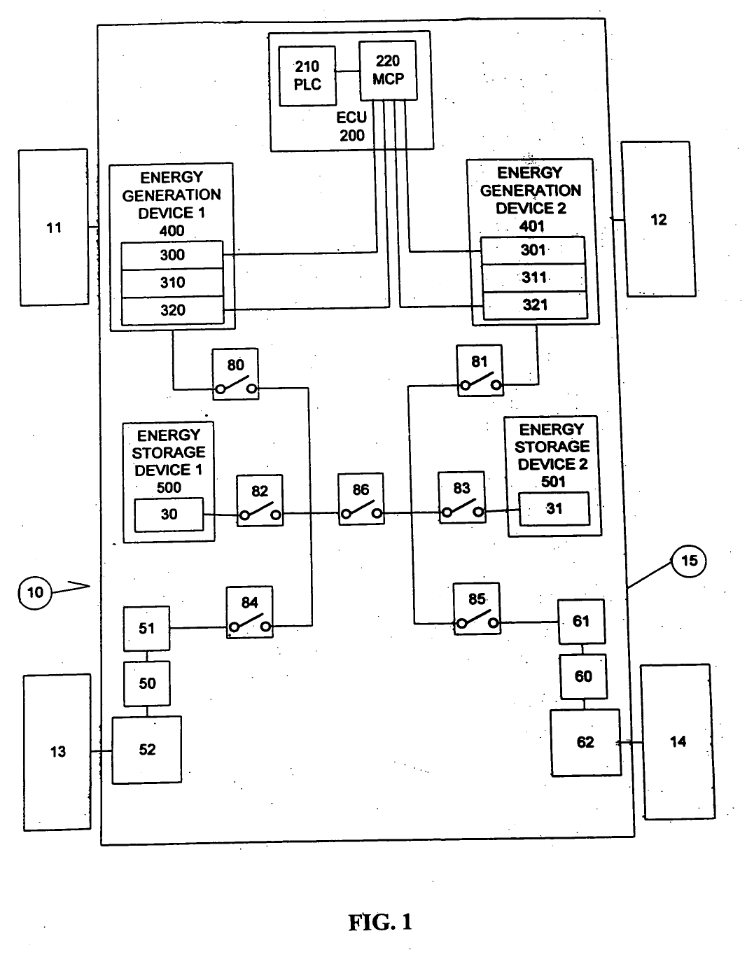

Referring to FIG. 1, an exemplary embodiment of a hybrid electric vehicle 10 according to the invention includes a plurality of wheels 11, 12, 13, and 14 and a vehicle chassis 15. The wheels 13, 14 are coupled to electric drive motors 50, 60, respectively, through gear boxes 52, 62, respectively. The wheels 13, 14 are independently mounted to respective suspension components, such as swing arms. In this embodiment, the wheels 13, 14 are not coupled together by an axle. In other embodiments, the wheels 13, 14 may be coupled together, for example, by an axle. The wheels 13, 14 may be either the front wheels or the rear wheels of the vehicle 10. In this embodiment, the wheels 11, 12 are not driven and may be coupled together by an axle. In other embodiments, the wheels 11, 12 may be driven.

In an exemplary embodiment of the vehicle according to the invention, the vehicle 10 is a bus having an occupancy capacity in excess of 100. However, it should be appreciated that the vehicle may be a bus of a smaller capacity or that the vehicle may be a smaller passenger vehicle, such as a sedan. In various exemplary embodiments, the vehicle may be any size and form currently used or later developed.

The electric drive motors 50, 60 are powered by energy storage devices 500, 501, such as by battery arrays 30, 31, and are controlled by drive motor controllers 51, 61, respectively. It will be appreciated that other energy storage devices, such as ultracapacitors, flywheels, and the like might be employed alone or in combination in the energy storage devices 500, 501, and that one energy storage device or a plurality of energy storage devices may be employed in various exemplary embodiments. According to an exemplary embodiment of the vehicle 10, the electric drive motors 50, 60 are synchronous, permanent magnet DC brushless motors. Each electric drive motor 50, 60 is rated for 220 Hp and 0-11,000 rpm. The maximum combined power output of the electric drive motors 50, 60 is thus 440 Hp. However, this invention is not limited to permanent magnet DC brushless motors, and other types of electric drive motors, such as AC induction motors, can be used.

The hybrid electric vehicle 10 is preferably a hybrid electric vehicle that also includes two energy generation devices 400, 401, which in an exemplary embodiment may include internal combustion engines 300, 301 and generators 310, 311 that are driven by the internal combustion engines 300, 301. The internal combustion engines 300, 301 may be powered by gasoline, diesel, or compressed natural gas. It should be appreciated, however, that the internal combustion engines 300, 301 and generators 310, 311 may be replaced by fuel cells, turbines or any other number of alternatives for creating usable electric power. According to an exemplary embodiment of the invention, the internal combustion engines 300, 301 may be 2.5 liter Ford LRG-425 engines powered by compressed natural gas. The engines 300, 301 are operated to produce 70 Hp each. It should be appreciated that the power of the engines 300, 301 may be increased by increasing the RPM of the engines 300, 301 and decreased by decreasing the RPM of the engines 300, 301. Other internal combustion engines can of course be utilized.

The generators 310, 311 are DC brushless generators that produce, for example, 240-400 V_{AC}. In an exemplary embodiment of the vehicle 10, the generators are operated to produce 345 V_{AC} during certain drive modes. An output shaft of the internal combustion engines 300, 301 are connected to the generators 310, 311 and the AC voltage of the generators 310, 311 is converted to a DC voltage by the generator controllers 320, 321. However, this invention is not limited to permanent magnet DC brushless generators, and other types of electric generators, such as AC induction generators, or other types of generators can be used. The converted DC voltage charges the energy storage devices 500, 501. The energy storage devices 500, 501 may each include, for example, 26 deep cycle, lead-acid batteries of 12 volts each connected in series. It should be appreciated, however, that other batteries, such as nickel cadmium, metal hydride or lithium ion, or that other energy storage devices, such as capacitors, ultracapacitors, or flywheels may be used and that any number of batteries or other devices may be employed, as space permits. Depending upon the load on the vehicle 10, the energy storage device voltages range between 240, 400 V_{DC}, although other voltage limits may be used.

An electronic control unit (ECU) 200 includes a programmable logic controller (PLC) 210 and a master control panel (MCP) 220. The MCP 220 receives input from various sensors and provides the connection to outputs in the vehicle 10 and the PLC 210 executes various programs to control, for example, the energy generation devices 400, 401, the energy storage devices 500, 501, the electric motors 50, 60, and the motor controllers 51, 61.

Although not shown in the drawings, the vehicle 10 includes a cooling system or cooling systems for the energy generation devices 400, 401, the energy storage devices 500, 501, and the motor controllers 51, 61. The cooling system may be a single system including a coolant reservoir, a pump for pumping the coolant through a heat exchanger such as a radiator and a fan for moving air across the heat exchanger or a plurality of cooling systems similarly constructed. The ECU 200 controls the cooling systems, including the pumps and the fans, to perform a heat shedding operation in which the heat generated by the engines 300, 301, the controllers 320, 321, 51, and 61, the energy storage devices 500, 501, and various other systems is released to the atmosphere. Any acceptable means and methods for cooling the vehicle components may be utilized.

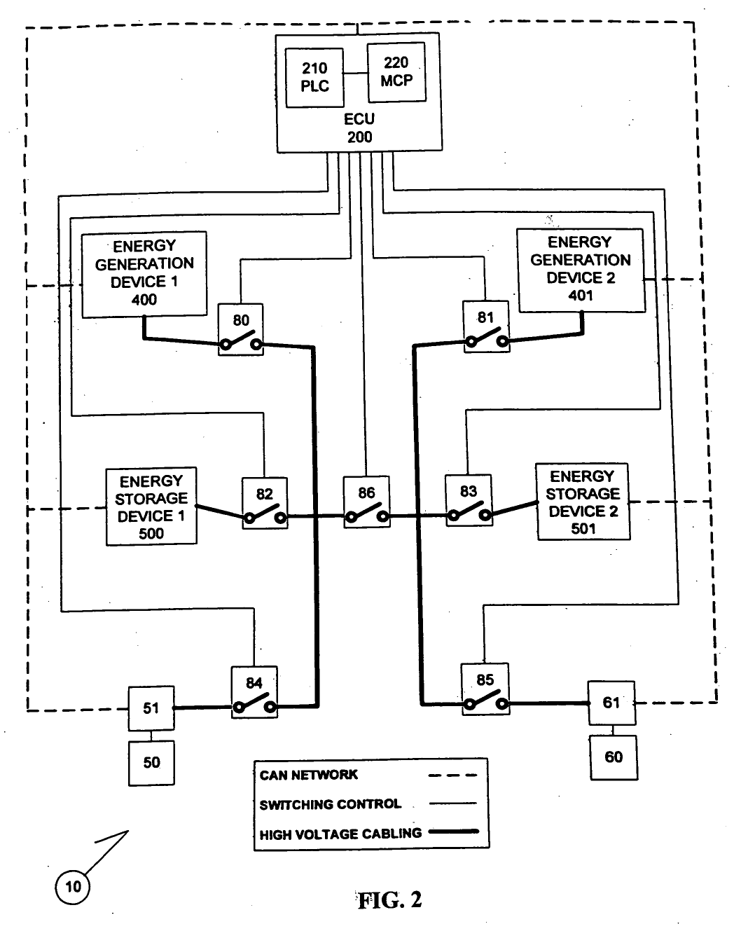

Each drive motor controller 51, 61 receives control data from the ECU 200 through a controller area network (CAN) (FIG. 2). The ECU 200 can communicate with the various sensors and the drive motor controllers 51, 61 by, for example, DeviceNet™, an open, global industry standard communication network.

Referring to FIG. 2, a schematic diagram of an exemplary embodiment of a hybrid electric vehicle architecture 100 according to the invention includes a plurality of electric drive motors 50, 60, which are controlled respectively, through drive motor controllers 51, 61.

In an exemplary embodiment of the vehicle architecture 100 according to the invention, the vehicle architecture 100 is installed on a bus having an occupancy capacity in excess of 100. However, it should be appreciated that the vehicle architecture may be employed on a bus of a smaller capacity or that the vehicle may be a smaller passenger vehicle, such as a sedan. In various exemplary embodiments, the vehicle may be any size and form currently used or later developed.

In an exemplary embodiment, the electric drive motors 50, 60 are linked through a high voltage electrical system to energy storage devices 500, 501. It will be appreciated that the energy storage devices 500, 501 may include any variety of energy storage devices, such as chemical batteries, ultracapacitors, flywheels, and the like, and these may be employed alone or in combination in the energy storage devices 500, 501, and that one energy storage device or a plurality of energy storage devices may be employed in various exemplary embodiments.

According to an exemplary embodiment of the vehicle 10, the electric drive motors 50, 60 are synchronous, permanent magnet DC brushless motors. However, this invention is not limited to permanent magnet DC brushless motors, and other types of electric drive motors, such as AC induction motors, can be used.

The hybrid electric vehicle architecture 100 preferably also includes two energy generation devices 400, 401, as detailed in FIG. 1, and which may include internal combustion engines coupled to generators, fuel cells, turbines or any other number of alternatives for creating usable electric power. According to an exemplary embodiment of the invention, energy generation devices 400, 401 employ 2.5 liter Ford LRG-425 engines powered by compressed natural gas. Other internal combustion engines can of course be utilized.

In an exemplary embodiment of the vehicle architecture 100, the energy generation devices 400, 401 are operated to produce 345 V_{AC} during certain drive modes. The high voltage DC output of the energy generation devices 400, 401 are linked to the energy storage system through a high voltage electrical system. The DC voltage output of the energy generation devices 400, 401 charges the energy storage devices 500, 501. The energy storage devices 500, 501 may each include, for example, 26 deep cycle, lead-acid batteries of 12 volts each connected in series. It should be appreciated, however, that other batteries, such as nickel cadmium, metal hydride or lithium ion, or that other energy storage devices, such as capacitors, ultracapacitors, or flywheels may be used and that any number of batteries or other devices may be employed, as space permits.

In an exemplary embodiment of the vehicle architecture 100, the energy generation devices 400, 401, the energy storage devices 500, 501, and the drive motors and controllers 50,51 and 60,61 are linked by a high voltage electrical system. As shown in FIG. 2, each device on the high voltage electrical system is isolated by one of a plurality of high voltage switching devices 80-86. In an exemplary embodiment, these switching devices may be a switching contactor type relay, capable of handling high currents and voltages. It will be appreciated that these switching devices may be replaced by other devices, such as high-speed IGBT switching devices, manual switches, or other systems, methods or types now available or not yet developed. In an exemplary embodiment, the switching devices are deployed in such a manner as to allow the elimination of a single or a plurality of hybrid electric components from the high voltage electrical system. This facilitates the arrangement of hybrid electric components into various system architectures to allow adaptive operation of the vehicle 10 in one of a multiplicity of component configurations and modes.

An electronic control unit (ECU) 200 includes a programmable logic controller (PLC) 210 and a master control panel (MCP) 220. The MCP 220 receives input from various sensors and provides the connection to outputs in the vehicle architecture 100 and the PLC 210 executes various programs to control, for example, the energy generation devices 400, 401, the energy storage devices 500, 501, the electric motors 50, 60, the motor controllers 51, 61, and the high voltage switching devices 80-86.

Each drive motor controller 51, 61 receives control data from the ECU 200 through a controller area network (CAN). The ECU 200 can communicate with the various sensors and the drive motor controllers 51, 61 by, for example, DeviceNet™, an open, global industry standard communication network. In the exemplary embodiment of FIG. 2, the hybrid electric components are controlled and operated by instructions over such a CAN network. The high voltage switching devices 80-86 are each controlled directly by the ECU, but may also be controlled by the CAN network.

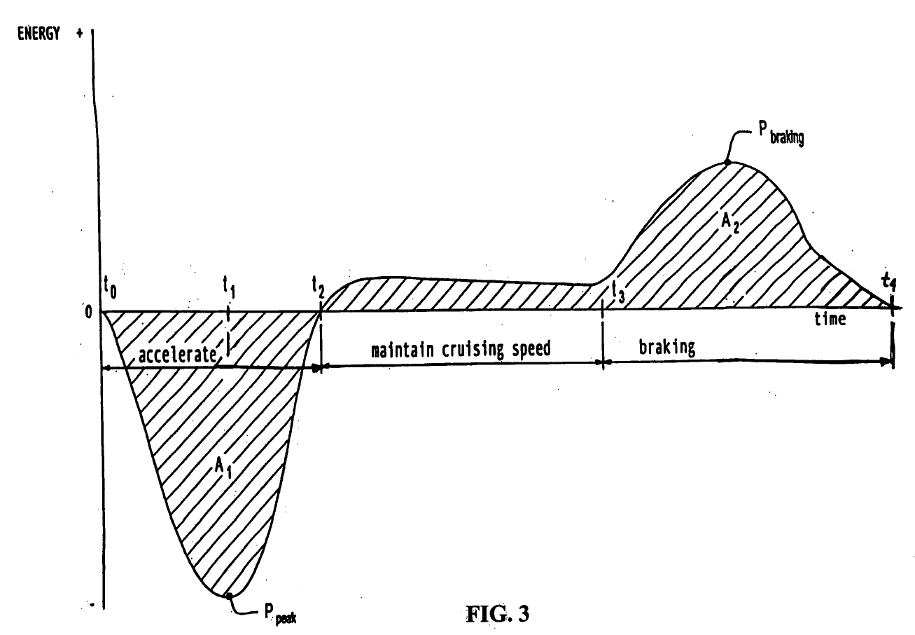

Referring to FIG. 3, the relationship between the power generated, the power stored, and the power consumed over time by the hybrid electric vehicle 10 according to an exemplary embodiment of the invention will be explained.

Power is consumed from the energy storage device 500 by the electric drive motors 50, 60 during acceleration of the vehicle 10 to a cruising speed. As shown in FIG. 3, the vehicle 10 reaches cruising speed at time t₁ corresponding to a peak power Pₚₑₐₖ of the electric drive motors 50, 60. The peak power Pₚₑₐₖ of the electric drive motors 50, 60 is dependent on the performance mode of the vehicle 10 selected by the operator. In the exemplary embodiment of the invention in which the electric drive motors 50, 60 are each 220 Hp, the peak power Pₚₑₐₖ consumed by the electric drive motors 50, 60 is 440 Hp.

The power consumption (traction effort) of the electric drive motors 50, 60 during acceleration is represented by the curve below the horizontal axis and the area defined by the curve below the horizontal axis between the times to and t₂ represents the total power consumption of the vehicle 10 during acceleration. In the event that the state of charge SOC of the energy storage devices 500, 501 is insufficient to achieve the cruising speed, the ECU 200 controls the motor controllers 51, 61 to limit the peak power Pₚₑₐₖ the electric drive motors 50, 60 may draw from the energy storage devices 500, 501. After the vehicle 10 has accelerated to cruising speed, the traction effort of the electric drive motors 50, 60 may be reduced between the time t₁ and a time t₂, and the power consumption by the electric drive motors 50 and 60 may also be reduced.

The cruising speed of the vehicle 10 is maintained between the time t₂ and a time t₃. During the time between t₂ and t₃, the energy generation devices 400, 401 are operated to produce power P_{gen} higher than the power consumption (traction effort) of the electric drive motors 50, 60 necessary to maintain the vehicle's crusing speed. The differential in power between the traction effort and the power generated P_{gen} is stored in the energy storage devices 500, 501.

The power P_{gen} generated by the energy generation devices 400, 401 is dependent, in an exemplary embodiment, on the rpm of the engines 300, 301 and a user demand signal sent to the energy generation devices 400, 401 that are controlled by the ECU 200. The ECU 200 controls the engines 300, 301 to generally maintain the rpm of the engines 300, 301, and the power generated P_{gen}, constant. However, it should be appreciated that the ECU 200 may control the engines 300, 301 to reduce or increase the rpm of the engines 300, 301, and thus the reduce or increase, respectively, the power generated P_{gen}.

The power generated P_{gen} by the energy generation devices 400, 401 may be reduced if the SOC of the energy storage devices 500, 501 approach an upper control limit at which the energy storage devices 500, 501 may become overcharged. The power generated P_{gen} by the energy generation devices 400, 401 may be increased if the SOC of the energy storage devices 500, 501 approach a lower control limit at which the energy storage devices 500, 501 would be unable to drive the electric drive motors 50, 60 with enough torque to propel the vehicle 10. It will be appreciated that the upper and lower control limits may be adaptively changed due to the determination of different performance modes, or by other determinations. In an exemplary embodiment of the vehicle 10 in which the engines 300, 301 are 2.5 liter Ford LRG-425 engines powered by compressed natural gas, the power generated P_{gen} is 140 Hp. An exemplary description of a method to select a driving or performance mode is detailed in co-pending U.S. patent application Ser. No. ______ (Attorney Docket 107168.03), the contents of which are hereby incorporated by reference herein in its entirety.

Regenerative braking occurs between the times t₃ and t₄ when the vehicle 10 decelerates after release of the accelerator pedal or when the vehicle 10 travels on a downhill slope at a constant speed. During regenerative braking, the electric drive motors 50, 60 function as generators and current is supplied to the energy storage devices 500, 501 by the electric drive motors 50, 60. The power generated P_{braking} during regenerative braking is stored in the energy storage devices 500, 501 or dissipated in a resistive load (not shown). It will be appreciated that the level of regenerative braking may be adaptively changed due to the determination of different performance modes, or by other determinations. An exemplary description of regenerative braking is detailed in co-pending U.S. patent application Ser. No. 10/413,544 filed Apr. 15, 2003, the contents of which are hereby incorporated by reference herein in its entirety.

The power generated by the energy generation devices 400, 401 during maintenance of the cruising speed and the power generated by regenerative braking P_{braking} is represented by the curve above the horizontal axis and the area defined by the curve above the horizontal axis represents the total energy creation and storage of the vehicle 10 during maintenance of the cruising speed and regenerative braking.

The power P_{gen} of the energy generation devices 400, 401 and the regenerative braking power P_{braking} are controlled by the ECU 200 to substantially equal the energy consumption (traction effort) of the electric drive motors 50, 60 during acceleration. In other words, the area defined by the curve below the horizontal axis is equal to the area defined by the curve above the horizontal axis. The ECU 200 controls the traction effort of the electric drive motors 50, 60 (including the peak power Pₚₑₐₖ) and the power generated P_{gen} so that the power generated and the power stored do not exceed the power consumed, and vice versa, so as to maintain the SOC of the energy storage devices 500, 501 within a range of control limits. The ECU 200 controls the power generated P_{gen} and the traction effort of the electric drive motors 50, 60 so that the ampere hours during energy consumption do not exceed the thermal capacity of the energy storage devices 500, 501 during power creation and storage.

As discussed above, in certain operational modes, the energy generation devices 400, 401 operate to produce power greater than the power consumption of the electric drive motors 50, 60. In various exemplary embodiments, the power output by the energy generation devices 400, 401 declines as the SOC of the energy storage devices 500, 501 approach a high level SOC. The energy storage devices 500, 501 are not fully charged, but managed to a SOC level predetermined to maximize the battery life and to accommodate the power requirements of the electric drive motors 50, 60. Thus, it should be appreciated that the energy storage devices 500, 501 can be maintained at any SOC level less than the maximum SOC level. By keeping the energy storage devices 500, 501 at less than the maximum SOC, the energy storage devices 500, 501 are less likely to experience mechanical or thermal failure due to overcharging.

Furthermore, the ECU 220 can determine the SOC of the energy storage devices 500, 501 over a period of time to determine if there are any trends in the SOC level. The trend can be an overall reduction, increase, or maintaining of the SOC of the energy storage devices 500, 501 over a predetermined period of time. The ECU 220 can then adjust the energy requirement of the energy generation devices 400, 401 accordingly.

An exemplary method and embodiment for adaptively controlling the state of charge SOC of the energy storage devices 500, 501 is disclosed in U.S. Pat. No. 6,333,620, the entire contents of which are herein incorporated by reference.

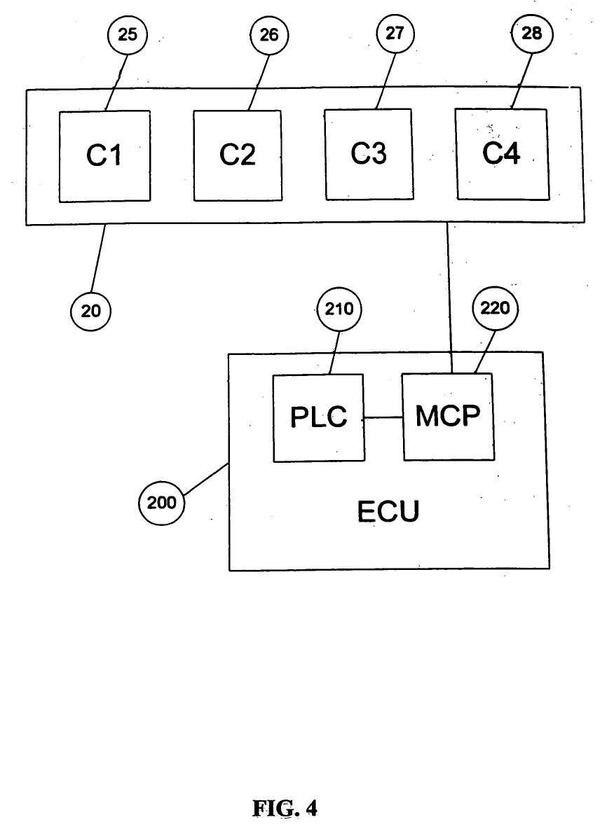

Referring to FIG. 4, a control panel 20 positioned, for example, in the operator area of the vehicle 10, includes a plurality of switches 25-28. In an exemplary embodiment, after starting the vehicle 10, one of the switches 25-28 is selected to establish a component configuration of the vehicle 10. A first component configuration C1 is established by selecting switch 25. In an exemplary embodiment, the first component configuration C1 is established for driving the vehicle in a redundant mode that employs duplicate components for energy generation, energy storage, and motive power. A second component configuration C2 is established by selecting switch 26. In an exemplary embodiment, the second component configuration C2 is established for driving the vehicle in a engine-electric configuration, where power travels directly from energy generation to motive power, excluding the use of energy storage components in the event of energy storage failures or high motive power requirements, such as from sustained high-speed operation.

A third component configuration C3 is established by selecting switch 27. In an exemplary embodiment, the third component configuration C3 is established for driving the vehicle in a reduced drive mode using only one or some of a multiplicity of drive motors, in the event of a drive motor failure or energy conservation due to a reduction of motive power requirements in low speed or governed operation. A fourth component configuration C4 is established by selecting switch 28. In an exemplary embodiment, the fourth component configuration C4 is established for driving the vehicle in a reduced energy generation mode, where one or some of a plurality of energy generation devices are disabled due to a component failure or reduced emissions requirements, such as operating in a neighborhood with restricted exhaust emissions.

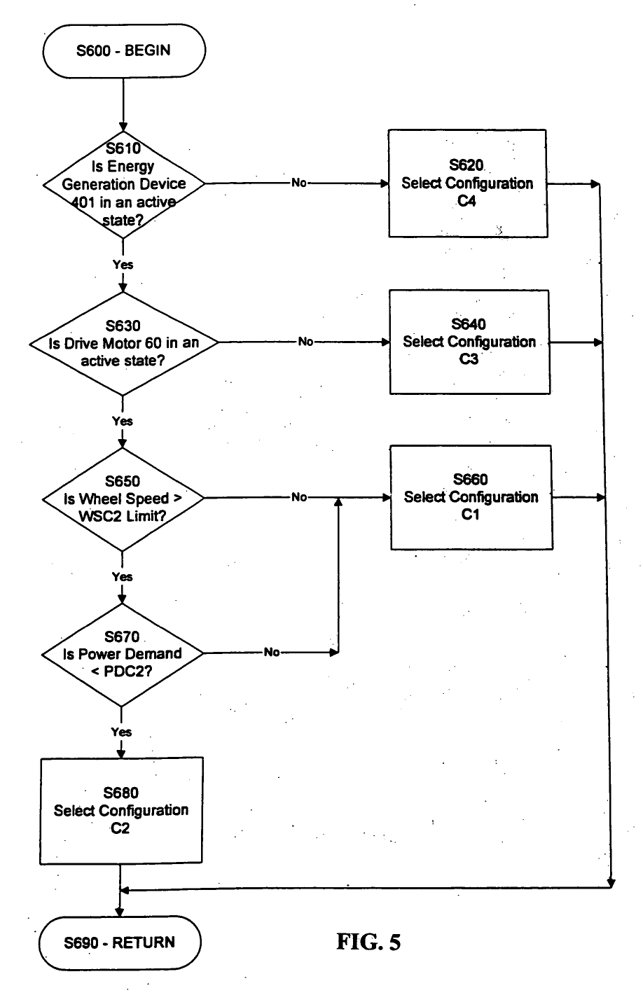

Referring to FIG. 5, a control is described for selecting a component configuration. In another exemplary embodiment, after starting the vehicle 10, the control is used to determine the component configuration of the hybrid electric vehicle. The control begins at step S600 and proceeds to step S610. In step S610, the control determines if the energy generation device 401 is in an active state. If it is in an active state (S610:Yes), the control proceeds to step S630. If it is not in an active state (S610:No), the energy generation device is not operational, and the control proceeds to step S620, where the component configuration C4 is selected. In an exemplary embodiment, the fourth component configuration C4 is established for driving the vehicle in a reduced energy generation mode, where one or some of a plurality of energy generation devices are disabled due to a component failure or reduced emissions requirements, such as operating in a neighborhood with restricted exhaust emissions. The control then proceeds to step S690, where it returns to the beginning.

In step S630, the control determines if the drive motor 60 is in an active state. If it is in an active state (S630:Yes) the control proceeds to step S650. If it is not in an active state (S630:No), the control proceeds to step S640, where configuration C3 is selected. In an exemplary embodiment, the third component configuration C3 is established for driving the vehicle in a reduced drive mode using only one or some of a multiplicity of drive motors, in the event of a drive motor failure or energy conservation due to a reduction of motive power requirements in low speed or governed operation. The control then proceeds to step S690, where it returns to the beginning.

In step S650, the control determines if the Wheel Speed measured is greater than the configuration C2 wheel speed limit WSC2. If Wheel Speed is greater than WSC2 (S650:Yes), the control proceeds to step S670. If Wheel Speed is less than or equal to WSC2 (S650:No), the control proceeds to step S660, where configuration C1 is selected. In an exemplary embodiment, the first component configuration C1 is established for driving the vehicle in a redundant mode that employs duplicate components for energy generation, energy storage, and motive power. The control then proceeds to step S690, where it returns to the beginning.

In step S670, the control determines if the vehicle Power Demand is less than the C2 power demand limit PDC2. If Power Demand is less than PDC2 (S670:Yes) the control proceeds to step S680, where component configuration C2 is selected. In an exemplary embodiment, the second component configuration C2 is established for driving the vehicle in a engine-electric configuration, where power travels directly from energy generation to motive power, excluding the use of energy storage components in the event of energy storage failures or high motive power requirements, such as from sustained high-speed operation. The control then proceeds to step S690, where it returns to the beginning.

If Power Demand is greater than or equal to PDC2 (S670:No), the control proceeds to step S660, where configuration C1 is selected. The control then proceeds to step S690, where it returns to the beginning.

Exemplary embodiments have been described for determining the component configuration of the hybrid electric vehicle 10. It will be appreciated that these or other methods may be used in the selection of a component configuration, and that the invention is not limited to these methods for selection of component configuration, rather that any suitable method for determining component configuration now in use or later developed may be used to select a component configuration.

In an exemplary embodiment, the ECU 200 controls the electric drive motors 50, 60, the energy storage device 500, the energy generation device 400, and other vehicle subsystems and components, not shown, depending upon which component configuration is established. In an exemplary embodiment, the first component configuration C1 indicates to the ECU 200 to generate command signals to operate the vehicle in a redundant state, where each energy generation device is operated in a similar, and parallel fashion, outputting similar amounts of power. Each of a plurality of energy storage devices are also employed in parallel, with similar discharge rates available from each and similar SOC maintained. Each electric drive motor is also operated in parallel to the other electric drive motors, outputting similar amounts of motive power and tractive torque, and maintaining equilibrium. Additional or different system parameters or limits may be established depending upon the component configuration established, and the systems, system parameters, and limits to be changed are not limited to electric drive motors, energy generation devices and energy storage devices as detailed in this embodiment. To the contrary, an unlimited number of systems and components may be controlled in the different component configurations, and an unlimited number of changes may be made to the system parameters and limits depending upon the component configuration selected.

While four illustrated component configurations are described, any number of configurations may be used, depending on the driving conditions, road conditions, weather conditions, vehicle component conditions and the like.

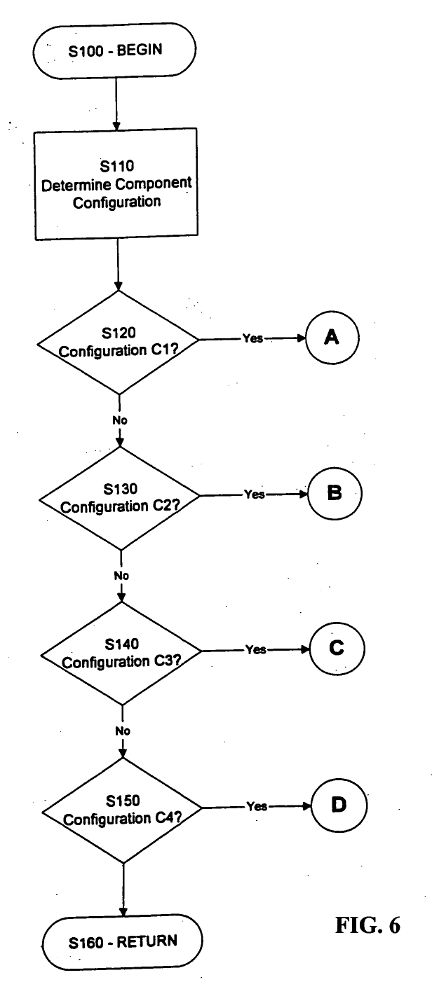

An exemplary embodiment for controlling the hybrid electric vehicle 10 will be explained with reference to FIGS. 6-10. The control method shown in FIGS. 6-10 may be automatically executed at predetermined times or locations during operation of the vehicle 10, by internal or remote signal to the ECU 200, or executed manually.

The control begins at step S100 and proceeds to step S110 where the ECU200 begins to determine the component configuration in which vehicle 10 should be operating.

The component configuration in which the vehicle 10 should be operating may be automatically determined by sensors on the vehicle 10, e.g. temperature probes, wheel speed sensors, weight sensors, moisture indicators, tire pressure monitors, etc. mounted on the vehicle 10. It should be appreciated that any automatic means currently available or later developed can be used for the vehicle 10 to determine what performance mode the vehicle 10 should be in. Also, a manual means, such as selection via a switch such as those described in FIG. 4, may be used by the operator or other to determine the component configuration to be employed by vehicle 10. It will be appreciated that the switches 25-28 in FIG. 4 are only an exemplary embodiment of an appropriate switch arrangement, and that other switching methods and quantities of switches and component configurations may be employed.

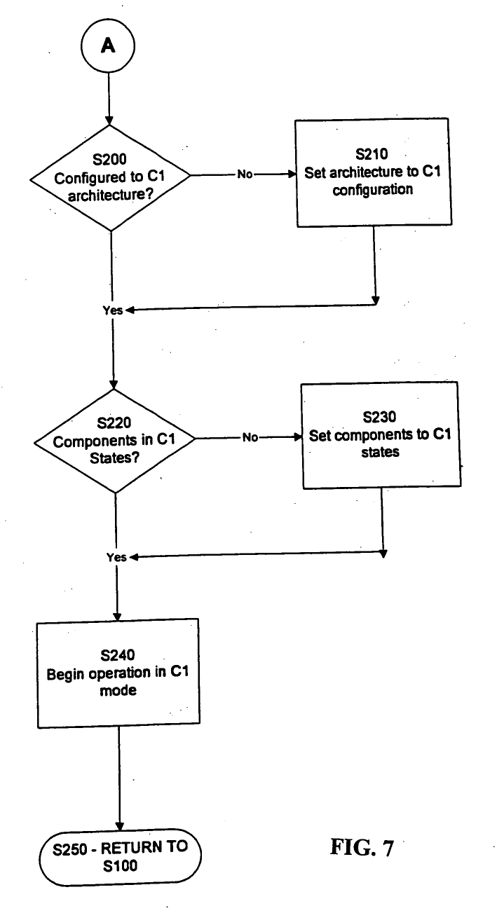

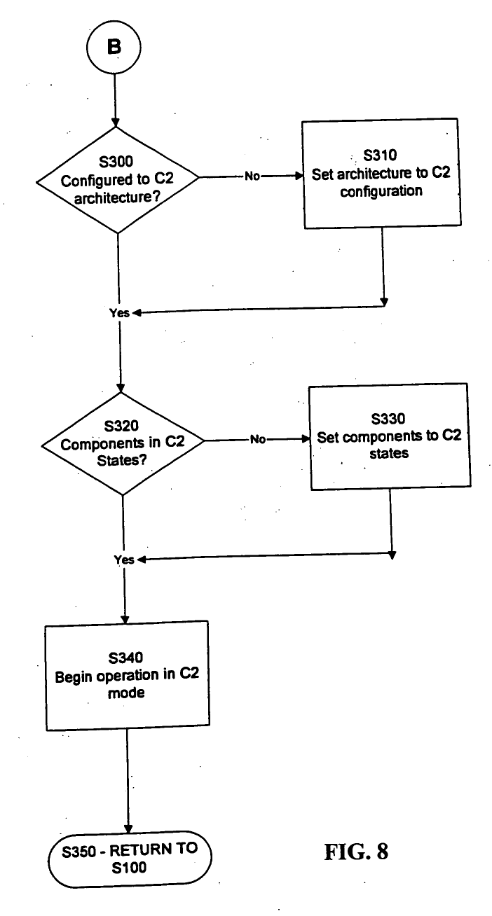

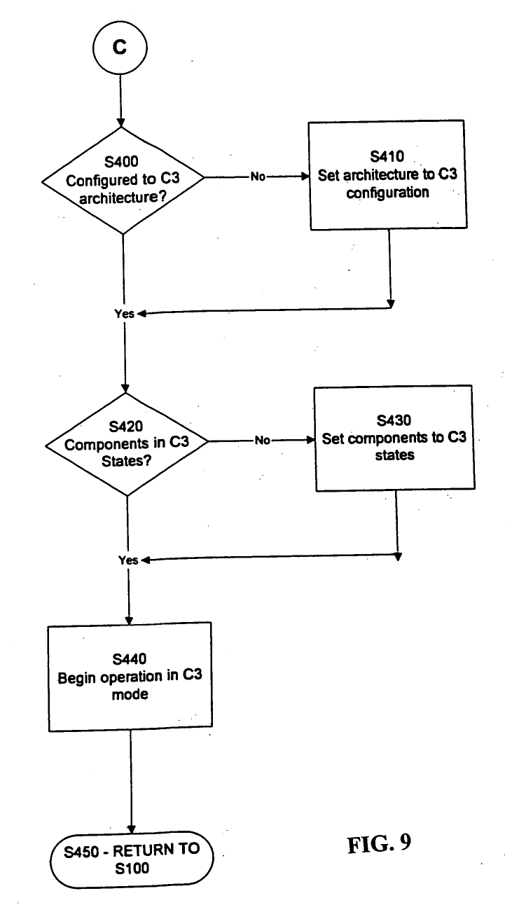

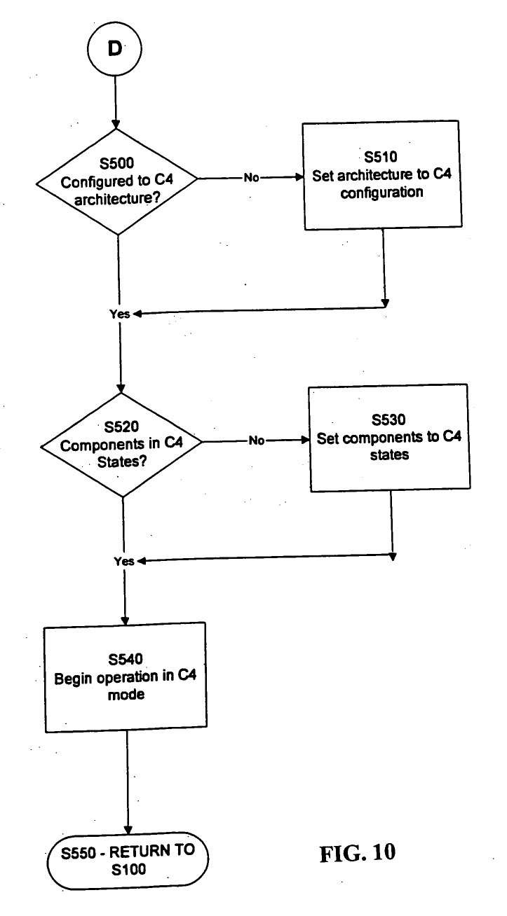

The control then proceeds to step S120 where it is determined if the component configuration C1 has been selected. If the vehicle component configuration C1 has been selected (S120: Yes) the control proceeds to step S200 (see FIG. 7). If the vehicle component configuration C1 has been selected (S120: No) the control proceeds to step S130, where it is determined if the vehicle component configuration C2 has been selected. If the vehicle component configuration C2 has been selected (S130: Yes) the control proceeds to step S300 (see FIG. 8). If the vehicle component configuration C2 has been selected (S130: No) the control proceeds to step S140, where it is determined if the vehicle component configuration C3 has been selected. If the vehicle component configuration C3 has been selected (S140: Yes) the control proceeds to step S400 (see FIG. 9). If the vehicle component configuration C3 has not been selected (S140: No) the control proceeds to step S150, where it is determined if the vehicle component configuration C4 has been selected. If the vehicle component configuration C4 has been selected (S150: Yes) the control proceeds to step S500 (see FIG. 10). If the vehicle component configuration C4 has not been selected (S150: No) the control proceeds to step S160, where it returns to the beginning.

When the control method proceeds to step S200 (see FIG. 7) the ECU 200 has determined that the vehicle 10 should be operating in component configuration C1. The ECU 200 then reviews the settings for the high voltage switching devices 80-86 to confirm they are in the appropriate predetermined settings for the C1 component configuration architecture. In an exemplary embodiment, these predetermined settings may be established from lookup tables in the ECU, by adaptive determination of the ECU as a result of various other vehicle inputs and states, or may be set manually by an operator or technician. Furthermore, additional methods for determining these settings may be used as they are developed or become available.

If it is determined that the vehicle 10 conforms to the settings of the C1 component configuration (S200: Yes) the control proceeds to step S220. If it is determined that the vehicle 10 does not conform to the settings of the C1 component configuration (S200: No), the control proceeds to step S210, where the high voltage switching devices 80-86 are set to the settings of the C1 component configuration architecture. In an exemplary embodiment where C1 is a redundant configuration, the high voltage switching devices 80-86 are all set active, to complete electrical circuits between the hybrid electric components. The control then proceeds to step S220.

In step S220, the control determines if all hybrid vehicle components are in the appropriate predetermined settings for the C1 component configuration. In an exemplary embodiment where C1 is a redundant configuration, the states of all hybrid electric components are set to an active state. It will be appreciated that the state of a component may include whether the component is active, disabled, or in a low energy “sleep” state. The state of a component may also include various internal settings and parameters that affect the functionality or performance of the individual component, or a particular operational mode the component might be capable of functioning in. It will be appreciated that any number or type of component state now defined or not yet implemented may be selected by a component configuration setting. In an exemplary embodiment, these predetermined states may be established from lookup tables in the ECU, by adaptive determination of the ECU as a result of various other vehicle inputs and states, or may be set manually by an operator or technician. Furthermore, additional methods for determining these settings may be used as they are developed or become available. If it is determined that the hybrid electric components are in the requisite states of the C1 component configuration (S220: Yes) the control proceeds to step S240. If it is determined that the hybrid electric components are not in the requisite states of the C1 component configuration (S220: No), the control proceeds to step S230, where the hybrid electric components are placed in the states of the C1 component configuration. The control then proceeds to step S240.

In step S240, the vehicle controller is instructed to begin operating in the component configuration C1, after verification that the component configuration architecture is set to a C1 configuration, and that the hybrid electric components have been set to C1 states. The control then proceeds to step S250, where it returns to step s100.

When the control method proceeds to step S300 (see FIG. 8) the ECU 200 has determined that the vehicle 10 should be operating in component configuration C2. The ECU 200 then reviews the settings for the high voltage switching devices 80-86 to confirm they are in the appropriate predetermined settings for the C2 component configuration architecture. In an exemplary embodiment, these predetermined settings may be established from lookup tables in the ECU, by adaptive determination of the ECU as a result of various other vehicle inputs and states, or may be set manually by an operator or technician. Furthermore, additional methods for determining these settings may be used as they are developed or become available. If it is determined that the vehicle 10 conforms to the settings of the C2 component configuration (S300: Yes) the control proceeds to step S320. If it is determined that the vehicle 10 does not conform to the settings of the C2 component configuration (S300: No), the control proceeds to step S310, where the high voltage switching devices 80-86 are set to the settings of the C2 component configuration architecture.

In an exemplary embodiment where C2 is an engine-electric drive configuration, the high voltage switching devices 80, 81, 84, 85, and 86 are set active, to complete electrical circuits between the hybrid electric components. The high voltage switching devices 82, 83 are set inactive, to open the electrical circuits to the energy storage devices 500, 501. The control then proceeds to step S320.

In step S320, the control determines if all hybrid vehicle components are in the appropriate predetermined settings for the C2 component configuration. In an exemplary embodiment where C2 is an engine-electric drive configuration, the states of the energy generation devices 400, 401 and the drive motors 50, 60 and drive motor controllers 51, 61 are set to an active state. The energy generation devices 400, 401 are set to a load-following state, where the output of the energy generation devices 400, 401 is in proportional response to a driver input command and subsequent output command to the drive motors 50, 60. The energy storage devices 500, 501 are set to an inactive state. It will be appreciated that the state of a component may include whether the component is active, disabled, or in a low energy “sleep” state. The state of a component may also include various internal settings and parameters that affect the functionality or performance of the individual component, or a particular operational mode the component might be capable of functioning in. It will be appreciated that any number or type of component state now defined or not yet implemented may be selected by a component configuration setting. In an exemplary embodiment, these predetermined states may be established from lookup tables in the ECU, by adaptive determination of the ECU as a result of various other vehicle inputs and states, or may be set manually by an operator or technician. Furthermore, additional methods for determining these settings may be used as they are developed or become available.

If it is determined that the hybrid electric components are in the requisite states of the C2 component configuration (S320: Yes) the control proceeds to step S340. If it is determined that the hybrid electric components are not in the requisite states of the C2 component configuration (S320: No), the control proceeds to step S330, where the hybrid electric components are placed in the states of the C2 component configuration. The control then proceeds to step S340.

In step S340, the vehicle controller is instructed to begin operating in the component configuration C2, after verification that the component configuration architecture is set to a C2 configuration, and that the hybrid electric components have been set to C2 states. The control then proceeds to step S350, where it returns to step

When the control method proceeds to step S400 (see FIG. 9) the ECU 200 has determined that the vehicle 10 should be operating in component configuration C3. The ECU 200 then reviews the settings for the high voltage switching devices 80-86 to confirm they are in the appropriate predetermined settings for the C3 component configuration architecture. In an exemplary embodiment, these predetermined settings may be established from lookup tables in the ECU, by adaptive determination of the ECU as a result of various other vehicle inputs and states, or may be set manually by an operator or technician. Furthermore, additional methods for determining these settings may be used as they are developed or become available. If it is determined that the vehicle 10 conforms to the settings of the C3 component configuration (S400: Yes) the control proceeds to step S420. If it is determined that the vehicle 10 does not conform to the settings of the C3 component configuration (S400: No), the control proceeds to step S410, where the high voltage switching devices 80-86 are set to the settings of the C3 component configuration architecture. In an exemplary embodiment where C3 is an reduced electric drive configuration, the high voltage switching devices 80, 81, 82, 83, 84, and 86 are set active, to complete electrical circuits between the hybrid electric components. The high voltage switching device 85 is set inactive, to open the electrical circuits to the electric drive motor 60 and drive motor controller 61. The control then proceeds to step S420. In step S420, the control determines if all hybrid vehicle components are in the appropriate predetermined settings for the C3 component configuration.

In an exemplary embodiment where C3 is a reduced electric drive configuration, the states of the energy generation devices 400, 401, the energy storage devices 500, 501, and the drive motor 50 and drive motor controller 51 are set to an active state. The drive motor 60 and drive motor controller 61 are set to an inactive state. Furthermore, the state of the active drive motor 50 and drive motor controller 51 is set to an increased power output limit consistent with compensating for some of the performance degradation associated with the inactive state of the drive motor 60 and drive motor controller 61. It will be appreciated that the state of a component may include whether the component is active, disabled, or in a low energy “sleep” state. The state of a component may also include various internal settings and parameters that affect the functionality or performance of the individual component, or a particular operational mode the component might be capable of functioning in. It will be appreciated that any number or type of component state now defined or not yet implemented may be selected by a component configuration setting. In an exemplary embodiment, these predetermined states may be established from lookup tables in the ECU, by adaptive determination of the ECU as a result of various other vehicle inputs and states, or may be set manually by an operator or technician. Furthermore, additional methods for determining these settings may be used as they are developed or become available.

If it is determined that the hybrid electric components are in the requisite states of the C3 component configuration (S420: Yes) the control proceeds to step S440. If it is determined that the hybrid electric components are not in the requisite states of the C3 component configuration (S420: No), the control proceeds to step S430, where the hybrid electric components are placed in the states of the C3 component configuration. The control then proceeds to step S440.

In step S440, the vehicle controller is instructed to begin operating in the component configuration C3, after verification that the component configuration architecture is set to a C3 configuration, and that the hybrid electric components have been set to C3 states. The control then proceeds to step S450, where it returns to step s100.

When the control method proceeds to step S500 (see FIG. 10) the ECU 200 has determined that the vehicle 10 should be operating in component configuration C4. The ECU 200 then reviews the settings for the high voltage switching devices 80-86 to confirm they are in the appropriate predetermined settings for the C4 component configuration architecture. In an exemplary embodiment, these predetermined settings may be established from lookup tables in the ECU, by adaptive determination of the ECU as a result of various other vehicle inputs and states, or may be set manually by an operator or technician. Furthermore, additional methods for determining these settings may be used as they are developed or become available.

If it is determined that the vehicle 10 conforms to the settings of the C4 component configuration (S500: Yes) the control proceeds to step S520. If it is determined that the vehicle 10 does not conform to the settings of the C4 component configuration (S500: No), the control proceeds to step S510, where the high voltage switching devices 80-86 are set to the settings of the C4 component configuration architecture. In an exemplary embodiment where C4 is an reduced energy generation configuration, the high voltage switching devices 80, 82, 83, 84, 85 and 86 are set active, to complete electrical circuits between the hybrid electric components. The high voltage switching device 81 is set inactive, to open the electrical circuit to the energy generation device 401. The control then proceeds to step S520.

In step S520, the control determines if all hybrid vehicle components are in the appropriate predetermined settings for the C4 component configuration. In an exemplary embodiment where C4 is a reduced energy generation configuration, the states of the energy generation device 400, the energy storage devices 500, 501, and the drive motors 50, 60 and drive motor controllers 51, 61 are set to an active state. The energy generation device 401 is set to an inactive state. Furthermore, the state of the active energy generation device 400 is set to an increased power output limit consistent with compensating for some of the performance degradation associated with the inactive state of the energy generation device 401. It will be appreciated that the state of a component may include whether the component is active, disabled, or in a low energy “sleep” state. The state of a component may also include various internal settings and parameters that affect the functionality or performance of the individual component, or a particular operational mode the component might be capable of functioning in. It will be appreciated that any number or type of component state now defined or not yet implemented may be selected by a component configuration setting. In an exemplary embodiment, these predetermined states may be established from lookup tables in the ECU, by adaptive determination of the ECU as a result of various other vehicle inputs and states, or may be set manually by an operator or technician. Furthermore, additional methods for determining these settings may be used as they are developed or become available.

If it is determined that the hybrid electric components are in the requisite states of the C4 component configuration (S520: Yes) the control proceeds to step S540. If it is determined that the hybrid electric components are not in the requisite states of the C4 component configuration (S520: No), the control proceeds to step S530, where the hybrid electric components are placed in the states of the C4 component configuration. The control then proceeds to step S540.

In step S540, the vehicle controller is instructed to begin operating in the component configuration C4, after verification that the component configuration architecture is set to a C4 configuration, and that the hybrid electric components have been set to C4 states. The control then proceeds to step S550, where it returns to step S100.

It will be appreciated by those skilled in the art that the ECU can be implemented using a single special purpose integrated circuit (e.g., ASIC) having a main or central processor section for overall, system-level control, and separate sections dedicated to performing various different specific computations, functions and other processes under control of the PLC. The ECU also can be a plurality of separate dedicated or programmable integrated or other electronic circuits or devices (e.g., hardwired electronic or logic circuits such as discrete element circuits, or programmable logic devices such as PLDs, PLAs, PALs, DSPs or the like). The ECU can be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the flowcharts shown in FIGS. 5-10 and described herein can be used as the ECU. A distributed processing architecture can be used for maximum data/signal processing capability and speed.

While the invention has been described with reference to various exemplary embodiments thereof, it is to be understood that the invention is not limited to the disclosed embodiments or constructions. To the contrary, the invention is intended to cover various modifications and equivalent arrangements. In addition, while the various elements of the disclosed invention are shown in various combinations and configurations, which are exemplary, other combinations and configurations, including more, less or only a single element, are also within the spirit and scope of the invention.

What is claimed is:

1. A method for adaptively controlling a hybrid electric vehicle including an energy generation system, an energy storage system receiving electric current at least from the generation system, and at least one electric motor receiving current from the energy storage system, the hybrid electric vehicle having the ability to operate in one of multiple predetermined component propulsion configurations, comprising:
determining a currently selected component configuration;
generating command signals to vehicle components to establish a defined component architecture;
generating command signals to vehicle components to establish component states corresponding to the determined component configuration; and
generating command signals to vehicle components for operation within determined parameters corresponding to the component configuration.

2. The method of claim 1, further comprising:
determining the component configuration based upon an operator input signal.

3. The method of claim 1, further comprising:
determining the component configuration based upon an externally supplied signal.

4. The method of claim 1, further comprising:
determining the component configuration based upon vehicle system states or conditions.

5. The method of claim 1, further comprising:
determining the component configuration based upon vehicle sensor states or measurements.

6. The method of claim 1, wherein the method specifies a component architecture of at least one energy generation device linked directly to at least one energy storage device and linked directly to at least one electric drive motor.

7. The method of claim 1, wherein the method specifies a component architecture of at least one energy generation device linked directly to at least one electric drive motor and isolating one or more energy storage devices from the at least one drive motor.

8. The method of claim 1, wherein the method specifies a component architecture of at least one energy generation device linked directly to at least one energy storage device and directly linked to at least one electric drive motor, where at least one other electric drive motor is isolated from the energy storage device and the energy generation device.

9. The method of claim 1, wherein the method specifies a component architecture including at least two energy storage devices, of which at least one energy generation device linked directly to at least one of the at least two energy storage devices and linked directly to at least one electric drive motor, where at least a second of the at least two energy storage devices is isolated from the at least one electric drive motor.

10. The method of claim 1, wherein the method specifies an upper and lower torque limit, power limit, or speed limit for operation of the electric drive motor.

11. The method of claim 1, wherein the method specifies an upper and lower energy generation limit for the energy generation device.

12. The method of claim 1, wherein the method specifies an upper and lower energy storage limit for the energy storage device.

13. The method of claim 1, wherein the step of generating command signals to establish component status includes switching various propulsion components out of electrical communication with other components.

14. A hybrid electric vehicle, comprising an energy generation system, an energy storage system receiving electric current at least from the generation system, and at least one electric motor receiving current from the energy storage system, and a vehicle controller containing multiple predetermined component propulsion configurations, wherein the controller:
determines the currently selected component configuration;
generates command signals to vehicle components to establish a defined component architecture;
generates command signals to vehicle components to establish states corresponding to the determined component configuration; and
generates command signals to vehicle components for operation within determined parameters corresponding to the component configuration.

15. The vehicle of claim 14, wherein the controller determines the component configuration based upon an operator input signal.

16. The vehicle of claim 14, wherein the controller determines the component configuration based upon an externally supplied signal.

17. The vehicle of claim 14, wherein the controller determines the component configuration based upon vehicle system states or conditions.

18. The vehicle of claim 14, wherein the controller determines the component configuration based upon vehicle sensor states or measurements.

19. The vehicle of claim 14, wherein the controller specifies a component architecture of at least one energy generation device linked directly to at least one electric drive motor and isolates one or more energy storage devices from the at least one electric drive motor.

20. The vehicle of claim 14, wherein the controller specifies a component architecture of at least one energy generation device linked directly to at least one energy storage device and directly linked to at least one electric drive motor, where at least one other electric drive motor is isolated from the at least one energy storage device.

21. The vehicle of claim 14, wherein the controller specifies a component architecture of at least one energy generation device linked directly to at least one electric drive motor and linked directly to at least one electric drive motor, where at least one other energy storage device is isolated;

22. The vehicle of claim 14, wherein the controller specifies an upper and lower torque limit, power limit, or speed limit for operation of the electric drive motor.

23. The vehicle of claim 14, wherein the controller generates an upper and lower torque limit, power limit, or speed limit for operation of the electric drive motor corresponding to the selected component configuration.

24. The vehicle of claim 14, wherein the controller generates an upper and lower energy generation limit for the energy generation device corresponding to the selected component configuration.

25. The vehicle of claim 14, wherein the controller generates an upper and lower energy storage limit for the energy storage device corresponding to the selected component configuration.

26. The vehicle of claim 14, wherein the at least one energy generation device, the at least one energy storage device, and the at least one electric drive motor are propulsion components electrically coupled together through a switching mechanism that can selectively electrically isolate one or more propulsion components from other propulsion components.

27. The vehicle of claim 26, wherein each propulsion component is separately coupled to other propulsion components through a switch mechanism.
